(19) United States
(12) Patent Application Publication
(10) Pub. No.: US 2008/0124125 A1
(43) Pub. Date: May 29, 2008

(54) IMAGE FORMING APPARATUS AND METHOD OF CONTROLLING SAME

(75) Inventor: Masayuki Hirano, Toride-shi (JP)

Correspondence Address: ROSSI, KIMMS & McDOWELL LLP., P.O. BOX 826, ASHBURN, VA, 20146-0826, US

(73) Assignee: CANON KABUSHIKI KAISHA, Tokyo (JP)

(21) Appl. No.: 11/944,152

(22) Filed: Nov. 21, 2007

(30) Foreign Application Priority Data
Nov. 24, 2006 (JP) 2006-317766

(51) Int. Cl. G03G 15/043; G03G 13/04

(52) U.S. Cl. 399/151

(57) ABSTRACT

Data indicative of charge unevenness caused by the photosensitive body is stored in a first memory, and data indicative of non-uniformity in amount of laser light regarding each reflecting face of the polygon mirror is stored in a second memory. A correction data generator executes processing based upon both types of data from the charge-unevenness data regarding the photosensitive body and the data indicative of non-uniformity in amount of laser light, and generates new correction data for correcting both charge unevenness and non-uniformity in amount of light. The amount of laser light is controlled by the correction data obtained, and it is possible to obtain a uniform image in which density unevenness is reduced.

### BACKGROUND OF THE INVENTION

1. Field of the Invention

The present invention relates to a technique for executing image formation processing by electrophotography using a laser printer or a copier, etc.

2. Description of the Related Art

In order to obtain a uniform image density in an image forming apparatus, a method known in the art is APC (Automatic Power Control), which is control for emitting a constant amount of laser light during one scan.

Even if control is executed to obtain a uniform amount of laser light, however, charge unevenness of a photosensitive body illustrated in FIGS. 7 and 8 and non-uniformity in amount of laser light (a decline in amount of laser light at both ends of the photosensitive body along the main-scan direction) in an OFS optical system shown in FIG. 9 occur. This is a cause of density unevenness at the time of image formation. Methods of solving these problems have been proposed in the past (see the specifications of Japanese Patent Application Laid-Open Nos. 2005-70069 and 2005-66827).

However, even if charge unevenness ascribable to the photosensitive body and non-uniformity of laser light in an OFS optical system are corrected for, the faces of a rotating polygon mirror are not all uniform and exhibit some variation. As a consequence, the non-uniformity in laser light differs from one face of the polygon mirror to another.

### SUMMARY OF THE INVENTION

The present invention enables the provision of a technique for forming a high-quality image by correcting for variations at the surfaces of a rotating polygon mirror.

According to one aspect of the present invention, the foregoing problems are solved by providing an image forming apparatus comprising a laser drive controller configured to generate a laser driving signal based upon an image signal, a laser light-emitting element configured to emit a laser beam in accordance with the laser driving signal, a rotating polygon mirror configured to scan an image carrier with the laser beam emitted by the laser light-emitting element, a first storage unit configured to store light-amount non-uniformity information relating to the laser that scans the image carried via the rotating polygon mirror, this information being stored for every reflecting face of the rotating polygon mirror, a correction data generating unit configured to generate correction data based upon the light-amount non-uniformity information stored in the first storage unit, a face sensing unit configured to sense a reflecting face of the rotating polygon mirror, and a laser light-amount controller configured to correct the amount of laser light using the correction data that corresponds to the reflecting face sensed by the face sensing unit.

According to one aspect of the present invention, the foregoing problems are solved by providing a method of controlling an image forming apparatus having a laser drive controller configured to generate a laser driving signal based upon an image signal, a laser light-emitting element configured to emit a laser beam in accordance with the laser driving signal, a rotating polygon mirror configured to scan an image carrier with the laser beam emitted by the laser light-emitting element, a first storage unit configured to store light-amount non-uniformity information relating to the laser that scans the image carried via the rotating polygon mirror, this information being stored for every reflecting face of the rotating polygon mirror, and a face sensing unit configured to sense a reflecting face of the rotating polygon mirror. The method comprises a step of generating correction data based upon the light-amount non-uniformity information stored in the first storage unit, and correcting the amount of laser light using the correction data that corresponds to the reflecting face sensed by the face sensing unit.

The present invention provides an image forming apparatus in which correction data is generated based upon information, which has been stored in first storage means, indicating non-uniformity of amount of light. A laser light-amount controller corrects the amount of laser light using the correction data that corresponds to a reflecting face sensed by face sensing means.

Further features of the present invention will become apparent from the following description of exemplary embodiments with reference to the attached drawings.

### BRIEF DESCRIPTION OF THE DRAWINGS

FIG. 1 is a diagram illustrating the basic structure of an image forming apparatus;

FIG. 2 is a diagram illustrating the structure of an exposure controller in the image forming apparatus;

FIG. 3 is a diagram illustrating the structure of a first embodiment of the present invention;

FIG. 4 is a diagram illustrating the generation of correction data according to the first embodiment (when a six-face polygon mirror is used);

FIG. 5 is a diagram illustrating the structure of a second embodiment of the present invention;

FIG. 6 is a diagram illustrating the generation of correction data according to the second embodiment (when a six-face polygon mirror is used);

FIG. 7 is a diagram illustrating charge unevenness of a photosensitive body along the main-scan direction;

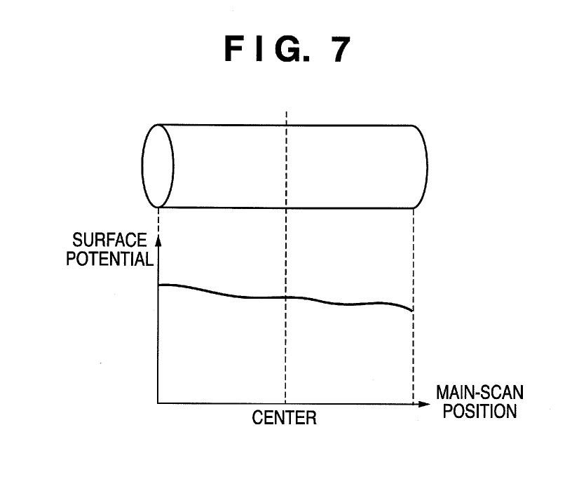

FIG. 8 is a diagram illustrating charge unevenness of a photosensitive body along the sub-scan direction;

FIG. 9 is a diagram illustrating non-uniformity in amount of laser light in an OFS optical system;

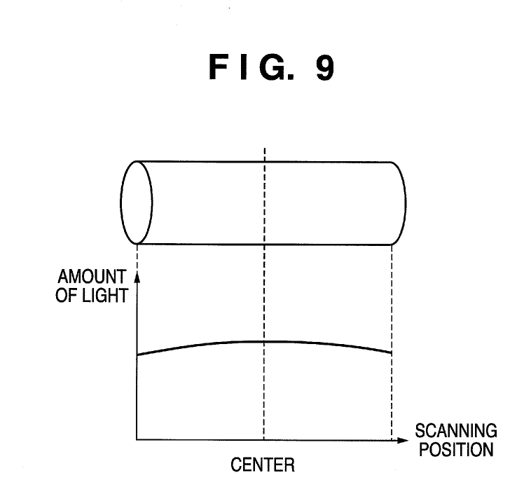

FIG. 10 is a flowchart illustrating a sequence according to the first embodiment;

FIG. 11 is a flowchart illustrating a sequence according to the second embodiment;

FIG. 12 is a flowchart illustrating a sequence for detecting the face of a polygon mirror; and

FIG. 13 is a flowchart illustrating a sequence for detecting scanning position of a photosensitive drum.

### DESCRIPTION OF THE EMBODIMENTS

Preferred embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

### First Embodiment

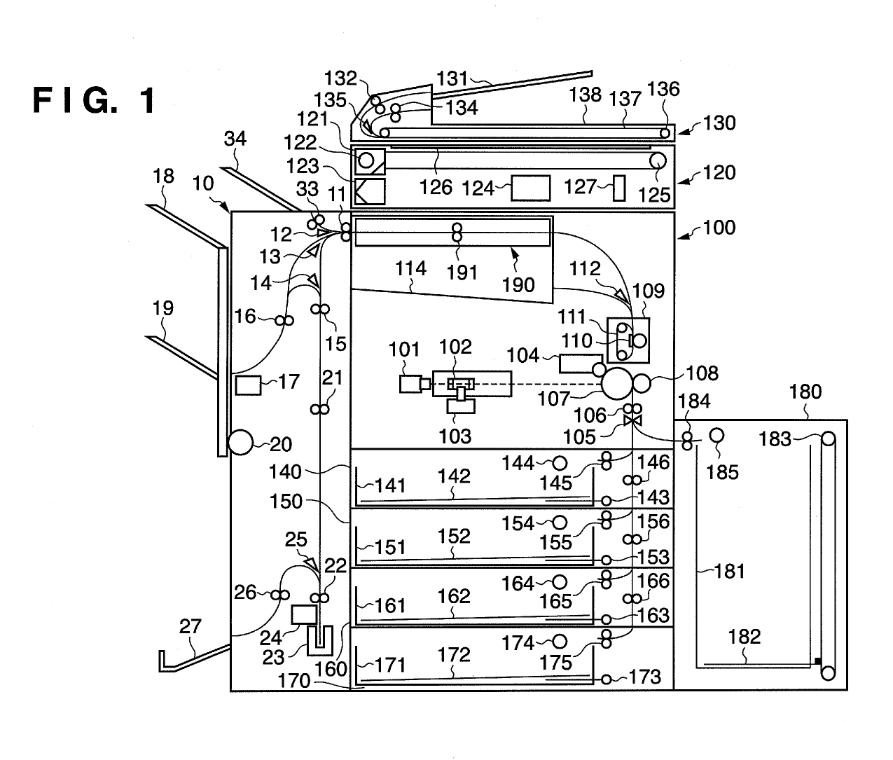

FIG. 1 is a diagram illustrating the basic structure of an image forming apparatus according to a first embodiment of the present invention. The structure of a document transport unit 130 will be described first. A document that has been placed on a platen 131 is fed to a document reading position one sheet at a time by paper feeding rollers 132. The document is placed at a prescribed reading position by a document conveyance belt 137 driven by a motor 136, and the operation for reading the document is performed by a document reader 120. After the document is read, the path of conveyance is changed by a flapper 135. The document is then ejected onto a drop tray 138 by rotating the motor 136 in the opposite direction.

The document reader 120 is constructed as follows: An exposure lamp 122, which comprises a fluorescent lamp or a halogen lamp, etc., illuminates a document on a document glass 126 while moving in a direction perpendicular to the longitudinal direction. Light that has scattered from the document owing to illumination by the exposure lamp 122 is reflected by a first mirror 121 and second mirror 123 so as to arrive at a lens 124. At this time the second mirror 123 is moved at a speed that is one-half that of the first mirror 121, and the distance from the illuminated surface of the original to the lens 124 is held constant at all times. The first mirror 121 and second mirror 123 are moved by the motor 125. The image on the document is formed on the photoreceptor of a CCD line sensor 127, which is composed of several thousand light-receiving elements arrayed in lines, via the mirrors 121, 123 and lens 124, and the image formed is sequentially opto-electronically converted line by line by the CCD line sensor 127. The signal obtained by the opto-electronic conversion is processed by a signal processor (not shown), subjected to a pulse-width modulation and output.

An image forming unit 100 is constructed as follows: An exposure controller drives a semiconductor laser 101, which includes a laser light-emitting element, based upon the pulse-width-modulated image signal that is the output of the signal processor, and illuminates the surface of a drum-shaped photosensitive body 107, which is rotating at uniform speed, by the laser light beam. At this time the light beam is deflected and made to scan in a direction parallel to the axial direction of the drum-shaped photosensitive body 107, which serves as the image carrier, using a polygon mirror 102 that is being rotated by a motor 103. It should be noted that before the photosensitive body 107 is illuminated by the light beam, residual electric charge on the drum is removed by a pre-exposure lamp (not shown) and the drum surface is then uniformly charged by a primary charging device, not shown. Accordingly, owing to illumination of the photosensitive body 107 by the light beam while the photosensitive body 107 is being rotated, an electrostatic latent image is formed on the drum surface. The electrostatic image on the drum surface is visualized by a developing unit 104 using a developer (toner) of a prescribed color.

Transfer paper conveyed from paper feeding means 140, 150, 160, 170, 180, described later, is conveyed to registration rollers 106. The latter senses the arrival of the transfer paper using a sensor 105 and feeds the transfer paper to a transfer position upon bringing the timing of the leading edge of the image that has been formed on the photosensitive body 107 and the timing of the leading edge of the transfer paper into agreement. A transfer charging device 108 transfers the toner image, which has been developed on the photosensitive body 107, to the transfer paper that has been fed to the transfer charging device. After the transfer, a cleaner (not shown) removes excess toner remaining on the photosensitive body 107. The transfer paper to which transfer has been completed readily separates from the photosensitive body 107 because the photosensitive body 107 has a large curvature. However, by further applying a voltage to a de-electrifying needle (not shown), the adsorption between the photosensitive body 107 and the transfer paper is weakened to facilitate the separation of the paper.

The separated transfer paper is sent to a fixing unit 109, where the toner is fixed to the paper. A ceramic heater 110 comprises a thin film 111 and two rollers. Heat from the ceramic heater 110 is transferred efficiently via the thin film 111. A cooling roller removes heat from the fixing rollers. Paper feeding rollers, which comprise two rollers, namely a large roller and a smaller roller, feed the transfer paper from the fixing unit and correct for the tendency of the transfer paper to curl up. A directional flapper 112 switches the discharge destination of the transfer paper between a tray 114 and a conveyance unit 190 depending upon the mode of operation.

The conveyance unit 190 is a unit for conveying the transfer paper to a post-processing unit 10, described later. The conveyance unit 190 conveys the transfer paper using conveyance rollers 191. The paper feeding means 140, 150, 160 and 170, which belong to the main body of the apparatus, comprise identical mechanisms. The paper feeding means 180 is a deck-type paper feeding stage that is capable of stacking and storing a larger quantity of sheets of transfer paper than the other paper feeding means 140, 150, 160 and 170.

Since the main-body paper feeding means 140, 150, 160 and 170 are substantially of the same structure, the structure will be described taking the paper feeding means 140 as an example. The paper feeding means 140 has a cassette 141 in which sheets of transfer paper are stacked and stored. A base plate 142 moved up and down by a lift-up motor 143 is disposed on the bottom surface of the cassette 141. Transfer paper can be made to standby at a prescribed standby height by lifting the base plate 142. Transfer paper waiting at the prescribed position is conveyed to a pair of paper feeding rollers 145 using a pick-up roller 144. The pair of paper feeding rollers 145 are subjected to a torque in a direction of rotation opposite that of paper feed, thereby feeding the transfer paper to a conveyance path one sheet at a time while preventing the feed of overlapping sheets. Further, transfer paper that has been conveyed from a paper feeding stage underlying the paper feeding means 140 is transported further upward by a pair of conveyance rollers 146.

The structure of the deck-type paper feeding means 180 is as follows: The paper feeding means 180 has a bin 181 in which sheets of transfer paper are stacked and stored. A base plate 182 for raising transfer paper up to a standby position is disposed on the bottom surface of the bin 181. The base plate 182 is connected to a belt rotated by a motor 183. The raising and lowering of the base plate 182 is controlled by movement of the belt. Transfer paper at the standby position is conveyed to a pair of paper feeding roller 184 by a pick-up roller 185. In a manner similar to that of paper feed in the main body of the apparatus, the transfer paper is conveyed to the conveyance path while sheets are prevented from being fed in overlapping form.

In the post-processing unit 10, transfer paper from the image forming unit 100 is accepted by rollers 11. In a case where a tray 34 has been selected as the destination of output of accepted transfer paper, the direction of conveyance is changed over by a flapper 12 and the transfer paper is ejected onto the tray 34 using rollers 33. The tray 34 is a discharge tray used temporarily. For example, the tray 34 is the destination of paper discharge in processing executed upon interrupting ordinary processing.

Trays for ordinary paper discharge are trays 18 and 19. Paper can be discharged into these trays by changing over the conveyance path to the downward direction by the flapper 12 and then selecting the conveyance path to rollers 16 by a flapper 13. In a case where the vertically downward direction is selected for the conveyance path by flappers 13 and 14 and the conveyance direction is reversed by inverting rollers 15, it is possible to discharge a sheet of transfer paper upon turning the sheet over. Further, whether the transfer paper is output to tray 18 or tray 19 is decided by moving the trays themselves up or down using a shift motor 20.

A tray 27 is a discharge tray used for bookbinding. Transfer paper is conveyed from the inverting rollers 15 to rollers 21. A prescribed amount of the transfer paper is stacked in a temporary storage section 23. Upon completion of storage of the paper, the sheets are subjected to a bookbinding operation by a stapler 24. The direction of a flapper 25 is changed over and rollers 22 are rotated in a direction opposite that in which they were rotated when the paper was stored in the storage section, thereby discharging the stapled sheets into the tray 27 via rollers 26.

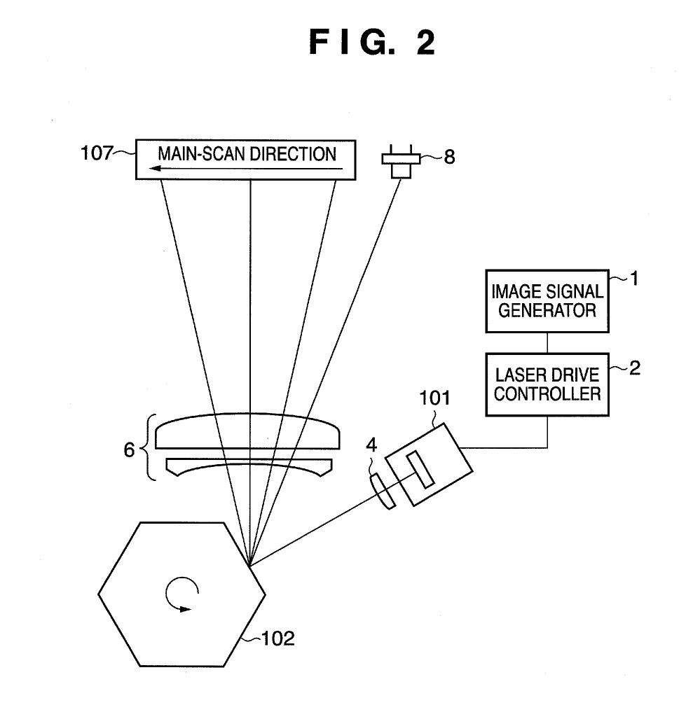

FIG. 2 is a diagram illustrating the structure of an exposure controller in the image forming apparatus. An image signal is acquired from a signal generator 1, and a laser driving signal is generated in a laser drive controller 2. The laser beam is emitted by a semiconductor laser 101 based upon the laser driving signal.

Laser light emitted by the semiconductor laser 101 emanates while spreading. The light therefore is collimated via a collimator lens 4 and impinges upon the rotating polygon mirror 102 having a plurality of laser reflecting faces. The polygon mirror 102 rotates at uniform angular speed. The laser light that impinges upon the polygon mirror 102 is reflected while the angle thereof is changed. The reflected light has its scanning speed corrected via an f-q lens 6. A BD sensor 8 detects the reflected light from the polygon mirror 102. When reflected light is detected, the BD sensor 8 generates a horizontal synchronizing signal for synchronizing the rotation of the polygon mirror 102 and the writing of data.

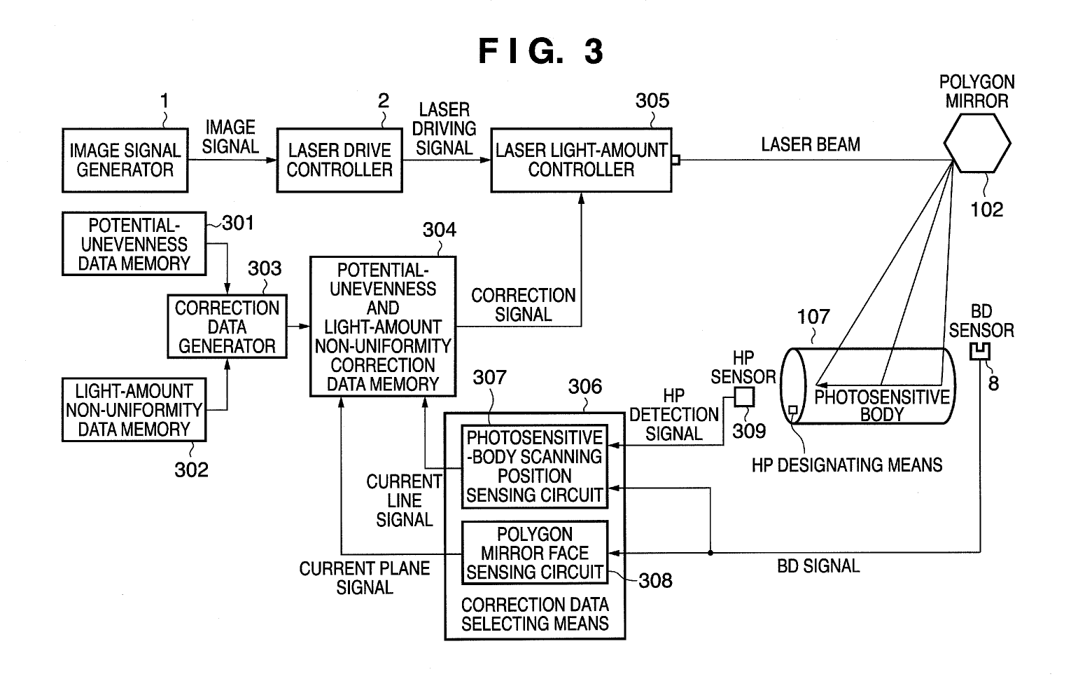

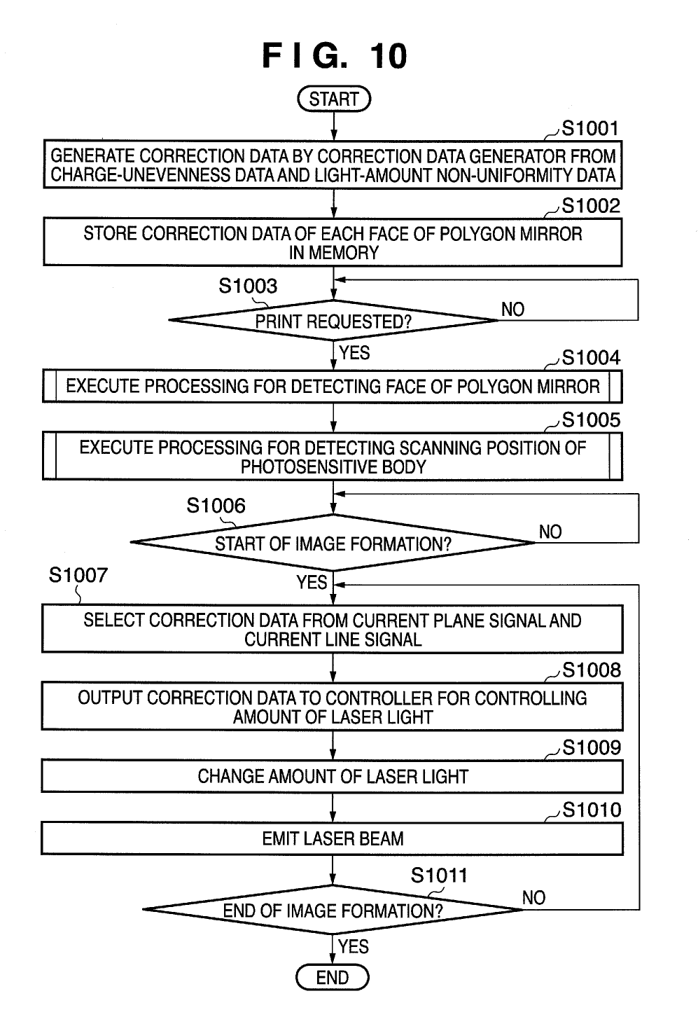

Next, reference will be had to FIG. 3 to describe an arrangement for executing processing that corrects for charge unevenness and non-uniformity in amount of laser light in the present embodiment. Further, reference will be had to the flowchart of FIG. 10 to describe the flow of processing using the components of FIG. 3.

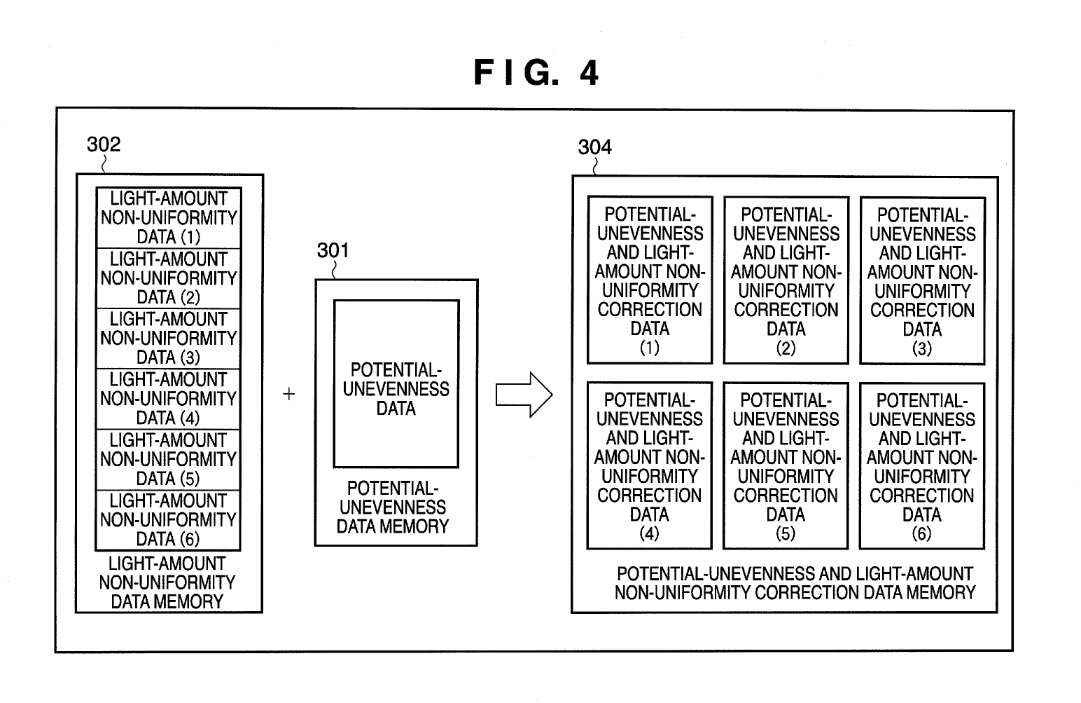

In FIG. 3, a correction data generator 303 serving as means for generating correction data receives an input of potential-unevenness data and light-amount non-uniformity data from a potential-unevenness data memory 301 serving as second storage means and a light-amount non-uniformity data memory 302 serving as first storage means. The correction data generator 303 generates data for correcting the potential-unevenness data as well as the light-amount non-uniformity data of each face of the polygon mirror (step S1001). The correction data generator 303 stores the correction data, which combines both corrections, is a memory 304 for potential-unevenness correction data and light-amount non-uniformity correction data (step S1002). The memory 304 serves as third storage means. Potential-unevenness correction data and light-amount non-uniformity correction data for each reflecting face of the polygon mirror 102 is stored in the memory 304. That is, in a case where use is made of a polygon mirror having n faces, n items of correction data for correcting potential unevenness and light-amount non-uniformity are stored. A conceptual view regarding the generation of correction data in the first embodiment is shown in FIG. 4.

Correction data generating means 306 includes a photosensitive-body scanning position sensing circuit 307 and a polygon mirror face sensing circuit 308 serving as face sensing means. If a print request is issued, control proceeds from step S1003 to step S1004, where the polygon mirror face sensing circuit 308 accepts a BD detection signal from the BD sensor 8. The polygon mirror face sensing circuit 308 then outputs a current plane signal indicating which reflecting face of the polygon mirror is used. The photosensitive-body scanning position sensing circuit 307 accepts an HP (Home Position) detection signal and the BD detection signal from an HP sensor 309 and the BD sensor 8, respectively. The photosensitive-body scanning position sensing circuit 307 outputs a current line signal, which indicates the scanning position of the photosensitive body 107 (S1005). The photosensitive body 107 serving as the image carrier has a home position serving as a reference position. This reference position is detected by the sensor 309 serving as detecting means.

When image formation starts, control proceeds from step S1006 to step S1007 and the CPU receives the current line signal and the current plane signal. Potential-unevenness correction data and light-amount non-uniformity correction data corresponding to the reflecting face of the polygon mirror and the scanning position of the photosensitive body is selected from the memory 304 for potential-unevenness correction data and light-amount non-uniformity correction data. The correction signal is output to a controller 305 for controlling the amount of laser light (S1008). The amount of laser light is adjusted by the controller 305 based upon the correction signal (S1009) and the photosensitive body 107 is scanned by the laser beam (S1010). If image formation is thus concluded, processing is exited from step S1011. If image formation has not ended, then control returns to step S1007 to scan the next line by the laser beam. That is, the correction data generator 303 serving as correction data generating means senses the laser reflecting face of the rotating polygon mirror at all times, specifies the relative position from the reference position on the image carrier illuminated by the reflected laser and generates correction data based upon reflecting face and the specified relative position.

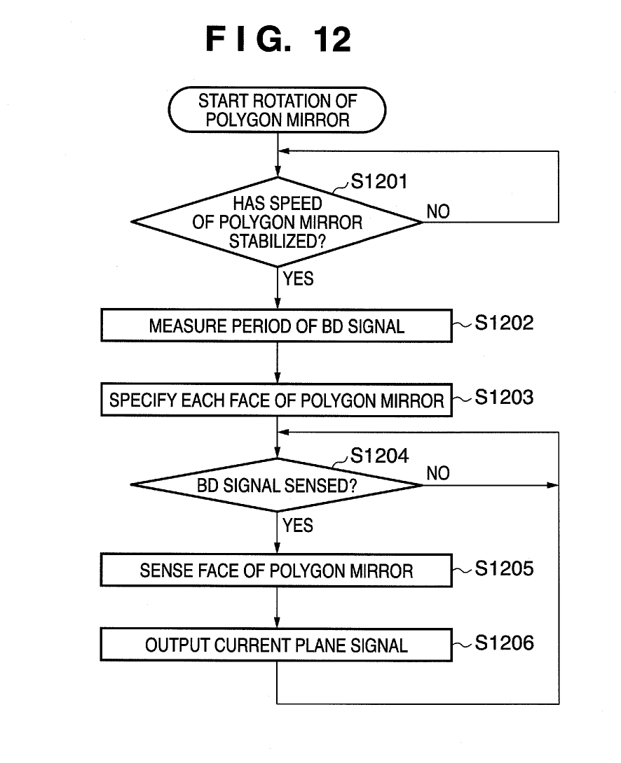

Described next will be the details of the processing (S1004) for detecting the face of the polygon mirror 102 and the processing (S1005) for detecting the scanning position of the photosensitive body. FIG. 12 is a flowchart illustrating the details of processing for detecting the face of a polygon mirror.

First, when a print request arrives, the polygon mirror starts being rotated and the system waits for the speed of the polygon mirror to stabilize (S1201). After the speed of the polygon mirror stabilizes, the BD sensor 8 outputs the BD signal and the period of the BD signal is measured (S1202). As a result, the length of each face of the polygon mirror is specified (S1203). Whenever the BD signal is accepted in the circuit that senses the face of the polygon mirror (S1204), the face of the polygon mirror is sensed (S1205) from the period of the PD signal and the current plane signal is output (S1206).

As a result of the series of processing steps shown in FIG. 12, it is possible to output the current plane signal indicating which face of the polygon mirror is being irradiated with the laser beam. In other words, which face of the polygon mirror is being irradiated with the laser beam can be ascertained.

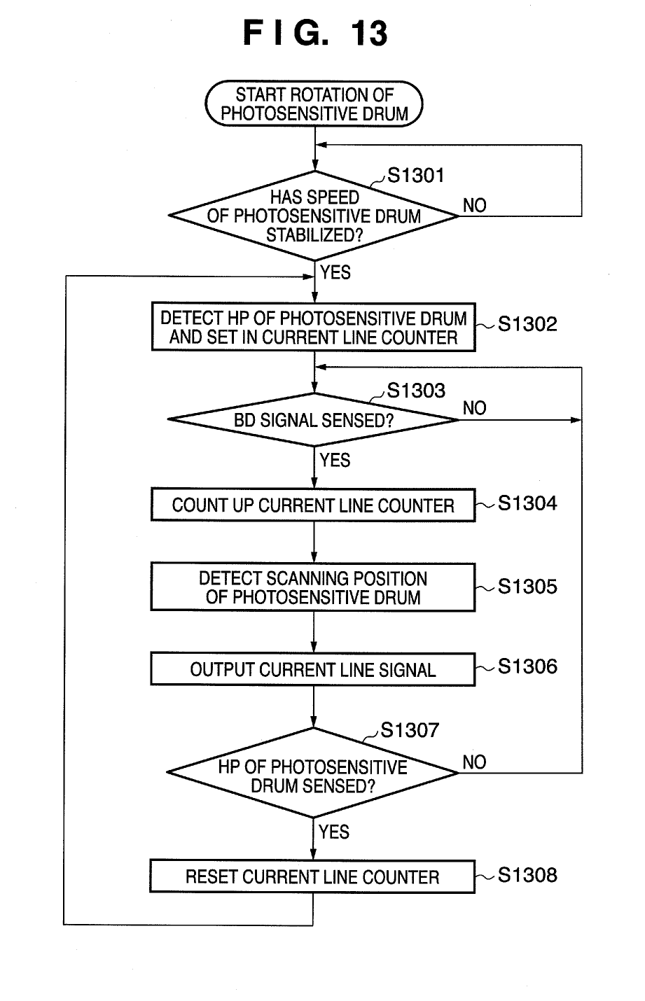

FIG. 13 is a flowchart illustrating processing for detecting the scanning position of the photosensitive body. First, when a print request arrives, the polygon mirror starts being rotated and the system waits for the speed of the polygon mirror to stabilize (S1301). The home position of the photosensitive drum is then detected by HP designating means and the HP sensor. The relative position from the home position serving as the reference position is set in a current line counter in the circuit that senses the scanning position of the photosensitive body (S1302). The BD signal from the BD sensor is sensed (S1303), the current line counter is counted up (S1304), the scanning position of the photosensitive body is decided (S1305) and the current line signal is output (S1306). Until the home position of the photosensitive body is sensed, the processing of steps S1303 to S1306 is executed whenever the BD signal is sensed. If the home position of the photosensitive body is sensed, control proceeds from step S1307 to step S1308, the current line counter is reset and control returns to step S1302. As a result, the relative position from reference position on the image carrier can be specified.

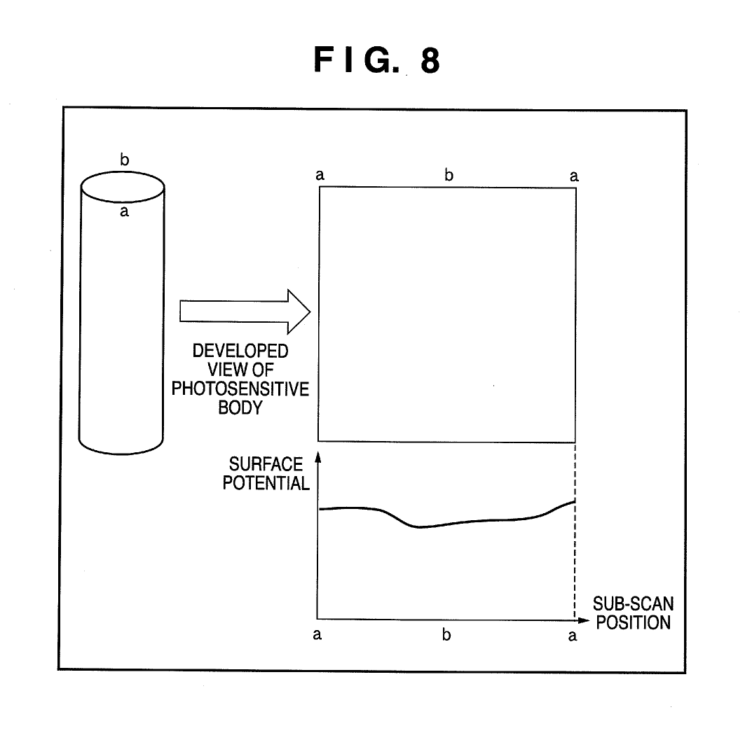

As a result of the series of processing steps shown in FIG. 13, it is possible to output the current line signal indicating at what angular position the photosensitive body 107 is located. In other words, what position along the horizontal axis of the graph shown at the bottom of FIG. 8 is being irradiated with the laser can be ascertained.

Thus, in accordance with this embodiment as described above, control for correcting the laser beam can be carried out taking into consideration the variation at each face of the polygon mirror. This makes it possible to obtain a high-definition image of more uniform quality.

### Second Embodiment

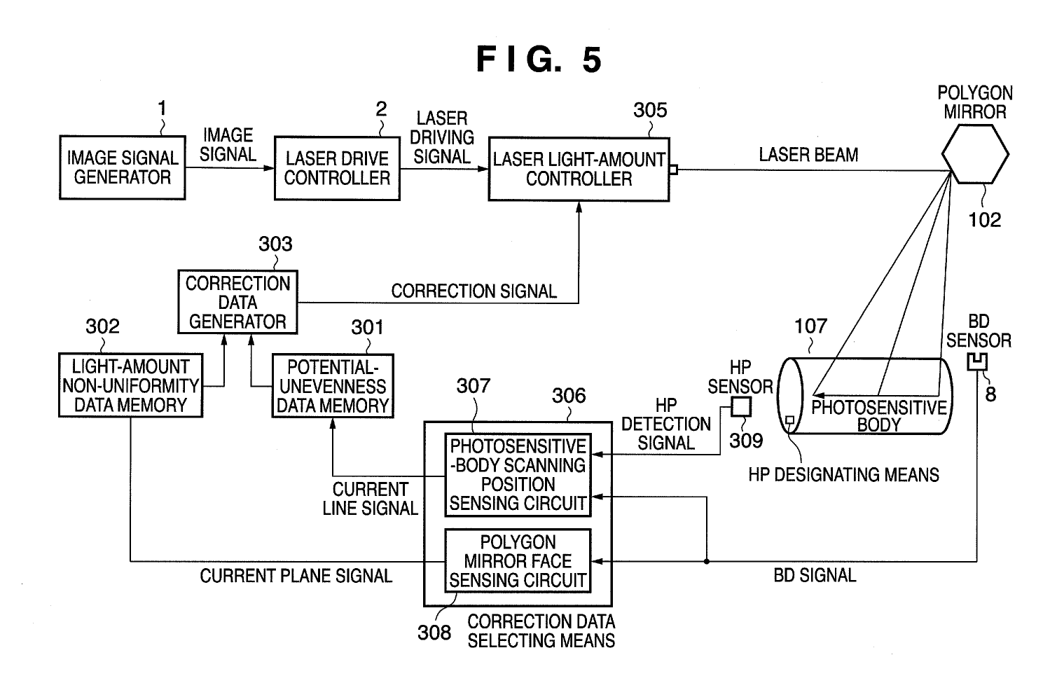

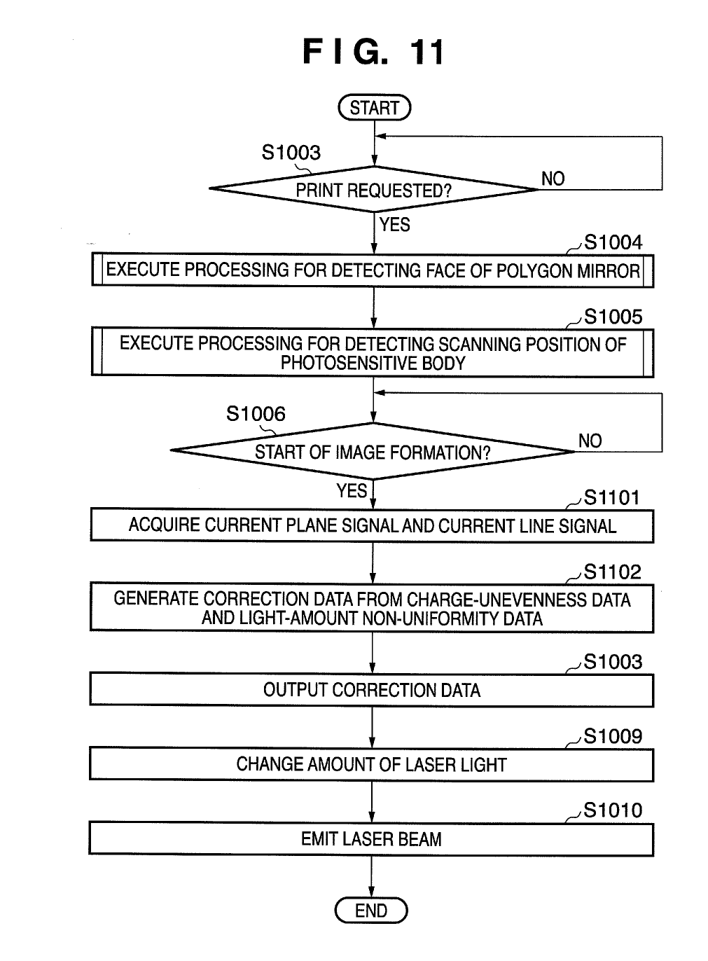

Next, reference will be made to FIG. 5 to describe an arrangement for executing processing that corrects for charge unevenness and non-uniformity in amount of laser light in a second embodiment of the present invention. Further, reference will be had to the flowchart of FIG. 11 to describe the flow of processing using the components of FIG. 5.

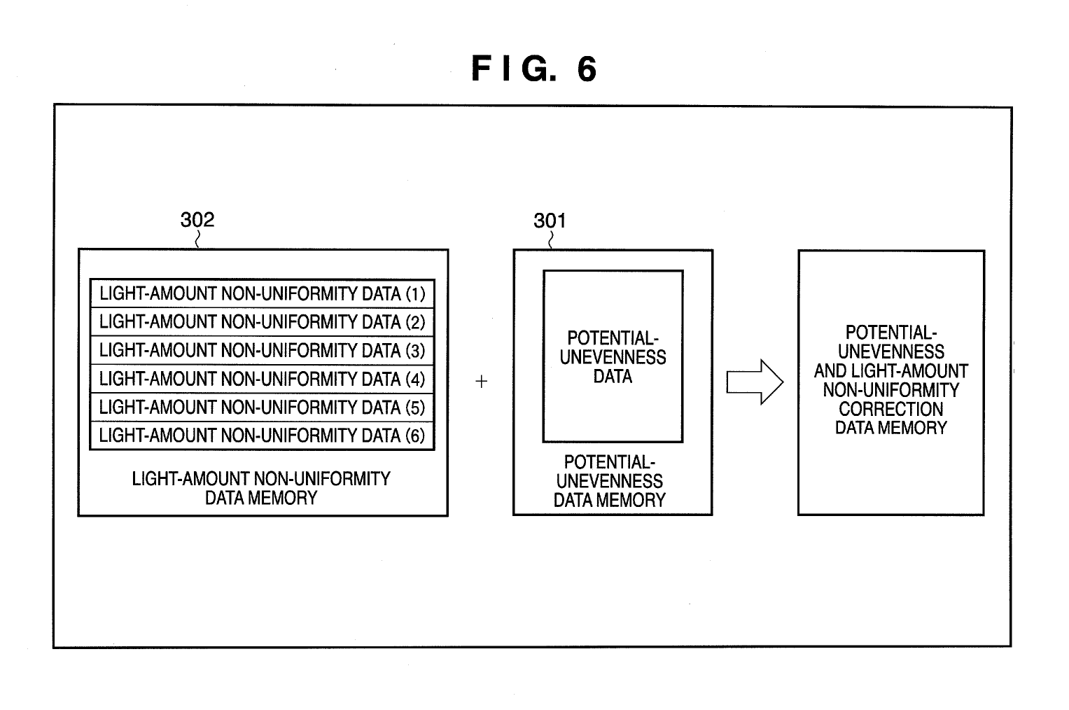

This embodiment does not include the memory 304 for potential-unevenness correction data and light-amount non-uniformity correction data of the first embodiment. Instead, the correction data for potential unevenness and for non-uniformity of amount of light is generated sequentially and input to the controller 305 for controlling the amount of laser light (FIG. 6).

The other components of the main body of the image forming apparatus and components of the exposure controller are similar to those of the first embodiment. Components and processing steps in FIGS. 5 and 11 identical with those of the first embodiment are designated by like reference characters and need not be described again.

At the start of image formation, the CPU acquires the current line signal and current plane signal (S1101). In accordance with the current line signal and current plane signal, the potential-unevenness data and light-amount non-uniformity data is selected from the potential-unevenness data memory 301 and memory 302 for storing the light-amount non-uniformity data of each face of the polygon mirror. The correction data generator 303 sequentially generates the correction data for the potential-unevenness data and light-amount non-uniformity data of each face of the polygon mirror conforming to the face of the polygon mirror and scanning position of the photosensitive body (S1102). The correction signal is output to the controller 305 that controls the amount of laser light (S1103). Based on the correction signal, the amount of laser light is adjusted by the controller 305 (S1009) and the laser beam is caused to scan across the photosensitive body (S1010).

The details of the processing for detecting the face of the polygon mirror and of the processing for detecting the scanning position of the photosensitive body are similar to the details as described in the first embodiment.

Further, a high-quality image can be provided at low cost without using expensive parts such as a highly precise photosensitive body having little charge unevenness or a highly uniform, highly precise polygon mirror.

Furthermore, by adopting the arrangement of the second embodiment, correction data is generated sequentially to correct the amount of laser light. As a result, memory capacity can be reduced since the apparatus does not have storage means for storing correction data for charge unevenness and for non-uniformity of amount of light for every reflecting face of a polygon mirror.

### Other Embodiments

Although embodiments of the present invention have been described above in detail, the present invention may be applied to a system constituted by a plurality of devices or to an apparatus comprising a single device.

Furthermore, the invention is attained also by supplying a program, which implements the functions of the foregoing embodiments, directly or remotely to a system or apparatus, reading the supplied program codes by the system or apparatus, and then executing the supplied program codes. Accordingly, since the functional processing of the present invention is implemented by computer, the computer codes per se installed in the computer also falls within the technical scope of the present invention.

In this case, so long as the system or apparatus has the functions of the program, the form of the program, for example, object code, a program executed by an interpreter or script data supplied to an operating system, etc., does not matter.

Examples of recording media for supplying the program are a Floppy (registered trademark) disk, hard disk, optical disk and magneto-optical disk. Further examples are a CD-ROM, CD-R, CD-RW, magnetic tape, a non-volatile type memory card, ROM and DVD (DVD-ROM, DVD-R), etc.

There is also a method of utilization that includes connecting to the Internet using the browser of a client personal computer, and downloading the program per se of the present invention or a file containing an automatic install function to a recording medium such as a hard disk. Further, implementation is possible by dividing the program code constituting the program into a plurality of files and downloading the files from different websites. In other words, a WWW server that downloads, to multiple users, the program files for implementing the functional processing of the present invention by computer also falls within the scope of the present invention. Further, the program according to the present invention may be encrypted, stored on a storage medium such as a CD-ROM and distributed to users. Users who meet certain requirements are allowed to download decryption key information from a website via the Internet, and it is possible to run the encrypted program upon decrypting it using the key information, whereby the program is installed in the computer.

Further, an operating system or the like running on the computer can perform all or a part of the actual processing based upon the indications in the program, and the functions of the embodiments described above can be implemented by this processing.

Furthermore, a case where the program according to the present invention is written to a memory provided in a function expansion unit of a personal computer and all or a part of the actual processing is executed by a CPU or the like provided in this function expansion unit also falls within the scope of the present invention.

In accordance with the present invention, non-uniformity in amount of laser light caused by non-uniformity in the reflecting faces of a rotating polygon mirror is corrected, thereby making it possible to reduce unevenness in the density of an image and form a high-quality image.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-317766, filed Nov. 24, 2006, which is hereby incorporated by reference herein in its entirety.

What is claimed is:

1. An image forming apparatus comprising:
a laser drive controller configured to generate a laser driving signal based upon an image signal;
a laser light-emitting element configured to emit a laser beam in accordance with the laser driving signal;
a rotating polygon mirror configured to scan an image carrier with the laser beam emitted by the laser light-emitting element;
a first storage unit configured to store light-amount non-uniformity information relating to the laser that scans the image carried via the rotating polygon mirror, this information being stored for every reflecting face of the rotating polygon mirror;
a correction data generating unit configured to generate correction data based upon the light-amount non-uniformity information stored in the first storage unit;
a face sensing unit configured to sense a reflecting face of the rotating polygon mirror; and
a laser light-amount controller configured to correct the amount of laser light using the correction data that corresponds to the reflecting face sensed by the face sensing unit.

2. The apparatus according to claim 1, further comprising a second storage unit adapted to store charge-unevenness information regarding charge on the image carrier;
wherein the correction data generating unit generates the correction data using both the light-amount non-uniformity information stored in the first storage unit and the charge-unevenness information stored in the second storage unit.

3. The apparatus according to claim 2, wherein the image carrier has a reference position, and the apparatus further comprises:
a detecting unit configured to detect the reference position; and
a unit configured to specify a relative position from the reference position on the image carrier;
and the correction data generating unit generates the correction data in accordance with the relative position specified.

4. The apparatus according to claim 1, further comprising a third storage unit configured to store the correction data, which has been generated by the correction data generating unit, for every reflecting face of the rotating polygon mirror.

5. The apparatus according to claim 1, wherein the correction data generating unit sequentially generates charge-unevenness and laser light-amount non-uniformity correction data from the light-amount non-uniformity information stored in the first storage unit, this correction data being generated for every reflecting face of the rotating polygon mirror.

6. A method of controlling an image forming apparatus having a laser drive controller configured to generate a laser driving signal based upon an image signal; a laser light-emitting element configured to emit a laser beam in accordance with the laser driving signal; a rotating polygon mirror configured to scan an image carrier with the laser beam emitted by the laser light-emitting element; a first storage unit configured to store light-amount non-uniformity information relating to the laser that scans the image carried via the rotating polygon mirror, this information being stored for every reflecting face of the rotating polygon mirror; and a face sensing unit configured to sense a reflecting face of the rotating polygon mirror; the method comprising:
a step of generating correction data based upon the light-amount non-uniformity information stored in the first storage unit, and correcting the amount of laser light using the correction data that corresponds to the reflecting face sensed by the face sensing unit.
